(19) United States
(12) Patent Application Publication
(10) Pub. No.: US 2025/0342561 A1
(43) Pub. Date: Nov. 6, 2025

(54) Device and method for forming a low-noise image from a burst of images

(71) Applicant: INSTITUT NATIONAL DE RECHERCHE EN INFORMATIQUE ET EN AUTOMATIQUE, LE CHESNAY (FR)

(72) Inventors: Bruno Lecouat, LE CHESNAY (FR); Jean Ponce, LE CHESNAY (FR); Julien Mairal, LE CHESNAY (FR)

(21) Appl. No.: 18/994,933

(22) PCT Filed: Jul. 6, 2023
(86) PCT No.: PCT/EP2023/068782

§ 371 Date: Jan. 15, 2025

(30) Foreign Application Priority Data
Jul. 22, 2022 (FR) 2207574

(51) Int. Cl. G06T 3/4053; G06T 3/4015; G06T 3/4046

(52) U.S. Cl. CPC G06T 3/4053; G06T 3/4015; G06T 3/4046

(57) ABSTRACT

A device for forming a high-resolution image from pairs formed of a low-resolution image and of an exposure time. The device includes: an estimator arranged to estimate, using a Lucas-Kanade algorithm, a distortion parameter for each low-resolution image; a processing unit arranged to obtain an initial high-resolution image; an alignment unit arranged to align a reference low-resolution image according to each distortion parameter; a convolutional neural network arranged to generate, for each low-resolution image, a confidence factor; a computer arranged to calculate, for each low-resolution image, an interference-removal weight; and an optimization module arranged to minimize a quadratic energy function with two variables: a high-resolution image estimation variable and an auxiliary variable initialized by the initial high-resolution image.

### CROSS-REFERENCE TO RELATED APPLICATIONS

This Application is a Section 371 National Stage Application of International Application No. PCT/EP2023/068782, filed Jul. 6, 2023, and published as WO 2024/017666 A1 on Jan. 25, 2024, not in English, which claims priority to and the benefit of French Patent Application No. 2207574, filed Jul. 22, 2022, the contents of which are incorporated herein by reference in their entireties.

### FIELD OF THE INVENTION

The field of the invention relates to the processing of a burst of images to form an image with a lower noise level than the images in the burst of images and a higher spatial resolution.

### BACKGROUND

Photographs taken with a mid-range camera or smartphone generally have high noise levels and low spatial resolution. These characteristics have an impact on the level of detail in the photograph: a low noise level makes it possible to distinguish details in dark areas, while a high spatial resolution makes it possible to zoom in on the photograph. In addition, the quality of the photograph may be altered by colour artefacts caused by bright colours.

A possible solution, for a photographic sensor of a given size, is to reduce the pixel size to increase the spatial resolution. However, the counterpart is an increase in noise in the dark areas, caused by the fact that each pixel receives a smaller quantity of photons. This phenomenon is particularly problematic with smartphones, in which the photographic sensor is generally smaller in size.

It is also known to use a plurality of photographs from the same scene—known as a burst of images—to construct a higher quality photograph, i.e. with lower noise and better spatial resolution. The images from the burst of images can be processed as RAW files—also known as raw images—i.e. digital image files containing the raw data for forming a visible image.

This principle is described in particular in the article by B. Wronski et al. (2019): “Handheld multi-frame super-resolution” (ACM Transactions On Graphics, vol. 38, No. 4, art. 28, p. 1-18) to increase the spatial resolution.

More recently, the inventors of the present invention, B. Lecouat, J. Ponce and J. Mairal, have proposed in a publication (2021): “Lucas-Kanade reloaded: end-to-end super resolution from raw image burst” (International Conference on Computer Vision (ICCV)), a solution which aligns raw images with sub-pixel precision, remains as faithful as possible to the data acquired by the photographic sensor and provides a high-performance regulariser function.

However, this solution has several disadvantages. In particular, it does not take into account the heterogeneity of the raw images, i.e. their respective exposure times, and nor does it provide deghosting. Furthermore, the optimisation proposed to minimise an energy function and solve an inverse problem is computationally intensive and time-consuming.

### SUMMARY

The present invention improves the situation.

In this respect, the invention relates to a device for forming an image having a first spatial resolution from a plurality of pairs each formed by an image having a second spatial resolution lower than or equal to the first spatial resolution and an exposure time. The device comprises:
an initialisation module arranged to receive the images having the second spatial resolution and comprising:
an estimator arranged to estimate, for each image having the second spatial resolution,
a distortion parameter by applying a Lucas-Kanade algorithm,
a processing unit arranged to apply, to at least one reference image having the second spatial resolution out of the images having the second spatial resolution, demosaicking and, when the second spatial resolution is lower than the first spatial resolution, scaling to obtain an initial image having the first spatial resolution, and
an optimisation module arranged to receive the images having the second spatial resolution, the associated distortion parameters and the initial image having the first spatial resolution and to minimise a quadratic energy function parameterised by an estimation variable of the image having the first spatial resolution and an auxiliary variable, the estimation variable of the image having the first spatial resolution and the auxiliary variable being initialised on the basis of the initial image having the first spatial resolution. The minimisation is performed by successive iterations, each comprising updating the auxiliary variable by a gradient descent as a function of the images having the second spatial resolution and associated distortion parameters and updating the estimation variable of the image having the first spatial resolution as a function of the updated auxiliary variable.

The device is characterised in that the initialisation module is arranged to further receive the respective exposure times of the images having the second spatial resolution and also comprises:
an alignment unit arranged to interpolate the reference image having the second spatial resolution as a function of each distortion parameter,
a convolutional neural network arranged to receive, as input, each image having the second spatial resolution and the reference image having the second spatial resolution aligned as a function of the associated distortion parameter and to generate, as output, a confidence factor,
a computer arranged to calculate, for each image having the second spatial resolution, a deghosting weight as a function of the corresponding exposure time and the associated confidence factor,
and in that the optimisation module is arranged to also receive the deghosting weights associated respectively with images having the second spatial resolution and comprises:
an updating unit arranged to update the auxiliary variable by gradient descent as a function of the deghosting weights.

In one or more embodiments, the initialisation module also comprises:
a convolutional neural network arranged to receive, as input, the images having the second spatial resolution and to generate, as output, a feature map for each image having the second spatial resolution,
and in that the estimator is arranged to apply the Lucas-Kanade algorithm to each feature map to estimate the distortion parameter associated with each image having the second spatial resolution.

Advantageously, the estimator is arranged to process each feature map, for the application of the Lucas-Kanade algorithm, in form of a Gaussian pyramid.

In one or more embodiments, the optimisation module also comprises:
a convolutional neural network arranged to receive, as input, the updated auxiliary variable and to generate, as output, the estimation variable of the updated image having the first spatial resolution.

Advantageously, the convolutional neural network of the optimisation module is arranged to implement weight sharing from one iteration to the other.

For example, the computer is arranged to calculate each deghosting weight as follows:

$${w}_{k} = \frac{Δ {t}_{k} {m}_{c} ( {y}_{k} )}{{\sum }_{j = 1}^{K} Δ {t}_{j} {m}_{c} ( {y}_{j} )} \cdot {g}_{ρ} ( {y}_{k} , {W}_{k} {y}_{k 0} )$$

where: —yₖ is the k-th image having the second spatial resolution,
Wₖ is the deghosting weight calculated for the image yₖ having the second spatial resolution,
Δtₖ is the exposure time of the image yₖ having the second spatial resolution,
K is the number of images having the second spatial resolution,
m_{c}( [symbol] ) is a binary mask replacing by zero any pixel value lower than or equal to a threshold C,
g_{ρ}is the confidence factor parameterised by a parameter ρ of the convolutional neural network,
Wₖ is a distortion operator characterised by the distortion parameter associated with the image yₖ having the second spatial resolution, and
yₖ₀ is the reference image having the second spatial resolution.

Advantageously, the alignment unit is arranged to align the reference image having the second spatial resolution as a function of each distortion parameter by bilinear interpolation.

In one or more embodiments, the processing unit is arranged to demosaic each image having the second spatial resolution, interpolate each demosaicked image having the second spatial resolution as a function of the associated distortion parameter, to form a image having the second spatial resolution by averaging the demosaicked and aligned images having the second spatial resolution and, when the second spatial resolution is lower than the first spatial resolution, to scale the formed image having the second spatial resolution to obtain the initial image having the first spatial resolution.

For example, the updating unit is arranged to update the auxiliary variable by gradient descent as follows:

$$z ← z - δ ( η ( z - x ) + {\sum }_{k = 1}^{K} {A}_{k}^{T} ( {w}_{k}^{2} \cdot ( {A}_{k} z - {y}_{k} ) ) )$$

with:

$${A}_{k} = Δ {t}_{k} {CD}_{s} {BW}_{k}$$

where: —z is the auxiliary variable,
x is the estimation variable of the image having the first spatial resolution,
yₖ is the k-th image having the second spatial resolution,
K is the number of images having the second spatial resolution,
Wₖ is the deghosting weight associated with the image yₖ having the second spatial resolution,
Δtₖ is the exposure time of the image yₖ having the second spatial resolution,
Wₖ is a distortion operator characterised by the distortion parameter associated with the image yₖ having the second spatial resolution,
C is a binary mask modelling a matrix of coloured filters,
s is the scaling factor used to obtain the initial image having the first spatial resolution,
Dₛ is a decimation operator characterised by the scaling factor s,
B is a blurring operator,
δ is a parameter of the gradient descent, and
η is a parameter of the quadratic energy function with two variables.

Typically, the optimisation module is arranged to implement three successive iterations.

In one or more embodiments, at least one convolutional neural network has a U-net type architecture.

The invention also relates to a method for forming an image having a first spatial resolution from a plurality of pairs each formed by an image having a second spatial resolution lower than or equal to the first spatial resolution and an exposure time. The method is implemented by the device described above and comprises:
an initialisation phase comprising the following operations:
receiving the images having the second spatial resolution,
estimating, for each image having the second spatial resolution, a distortion parameter by applying a Lucas-Kanade algorithm,
applying, to at least one reference image having the second spatial resolution out of the images having the second spatial resolution, a demosaicking and, when the second spatial resolution is lower than the first spatial resolution, scaling to obtain an initial image having the first spatial resolution, and
an optimisation phase comprising the following operations:
receiving the images having the second spatial resolution, the associated distortion parameters and the initial image having the first spatial resolution,
minimising a quadratic energy function parameterised by an estimation variable of the image having the first spatial resolution and an auxiliary variable, the estimation variable of the image having the first spatial resolution and the auxiliary variable being initialised on the basis of the initial image having the first spatial resolution. The minimisation is performed by successive iterations, each comprising updating the auxiliary variable by gradient descent as a function of the images having the second spatial resolution and associated distortion parameters and updating the estimation variable of the image having the first spatial resolution as a function of the updated auxiliary variable.

The method is characterised in that the initialisation phase comprises the following operations:
receiving the respective exposure times of the images having the second spatial resolution,
aligning by interpolation the reference image having the second spatial resolution as a function of each distortion parameter,
using a convolutional neural network receiving, as input, each image having the second spatial resolution and the reference image having the second spatial resolution aligned as a function of the associated distortion parameter and generating, as output, a confidence factor,
calculating, for each image having the second spatial resolution, a deghosting weight as a function of the corresponding exposure time and the associated confidence factor,
and in that the optimisation phase comprises the following operations:
also receiving the deghosting weights associated respectively with the images having the second spatial resolution,
updating the auxiliary variable by gradient descent as a function of the deghosting weights.

In one or more embodiments, the method also comprises a pretraining phase of the device with a training data set comprising an image having the first spatial resolution and a plurality of pairs each formed by an image having the second spatial resolution and an exposure time, each image having the second spatial resolution being generated from the image having the first spatial resolution as follows:

$${y}_{k}^{( 1 )} = {A}_{k}^{( 1 )} {x}^{( 1 )} + {ε}_{k}^{( 1 )}$$

with:

$${A}_{k}^{( 1 )} = Δ {t}_{k}^{( 1 )} {C}^{( 1 )} {D}_{S}^{( 1 )} {B}^{( 1 )} {w}_{k}^{( 1 )}$$

where: —x⁽¹⁾ is the image having the first spatial resolution of the training data set,
yₖ⁽¹⁾ is the k-th image having the second spatial resolution of the training data set,
Δtₖ⁽¹⁾ is the exposure time of the image yₖ⁽¹⁾ having the second spatial resolution,
Wₖ⁽¹⁾ is a distortion operator associated with the image yₖ⁽¹⁾ having the second spatial resolution,
C⁽¹⁾ is a binary mask modelling a matrix of coloured filters,
Dₛ⁽¹⁾ is a decimation operator characterised by a scaling factor s,
B⁽¹⁾ is a blurring operator,
εₖ⁽¹⁾ is a noise associated with the image yₖ⁽¹⁾ having the second spatial resolution.

Advantageously, the pre-training phase is supervised by using a plurality of training data sets, each comprising an image having the first spatial resolution and a plurality of pairs each formed by an image having the second spatial resolution and an exposure time. The supervised pre-training phase enables the device to be parameterised so as to minimise the following quantity:

$${\sum }_{i = 1}^{n} {‖ {x}^{( i )} - {\hat{x}}^{( i )} ‖}_{1}$$

where: —x⁽ⁱ⁾ is the image having the first spatial resolution of the i-th training data set,
\hat{x}⁽ⁱ⁾ is the image having the first spatial resolution estimated by the device from the i-th training data set, and
n is the number of training data sets.

Finally, the invention also relates to a computer program comprising instructions whose execution by at least one processor results in the implementation of the method described above.

### BRIEF DESCRIPTION OF THE DRAWINGS

Other features, details and advantages will become apparent upon reading the detailed description hereinafter, and from the analysis of the appended drawings, wherein:

FIG. 1 shows a device for forming an image of a first spatial resolution from a burst of images of a second spatial resolution according to the invention;

FIG. 2 shows a method for forming an image of a first spatial resolution from a burst of images of a second spatial resolution according to the invention;

FIG. 3 shows an initialisation phase of the method of FIG. 2;

FIG. 4 shows an optimisation phase of the method of FIG. 2; and

FIG. 5 shows a training phase of the method of FIG. 2

### DETAILED DESCRIPTION OF ILLUSTRATIVE EMBODIMENTS

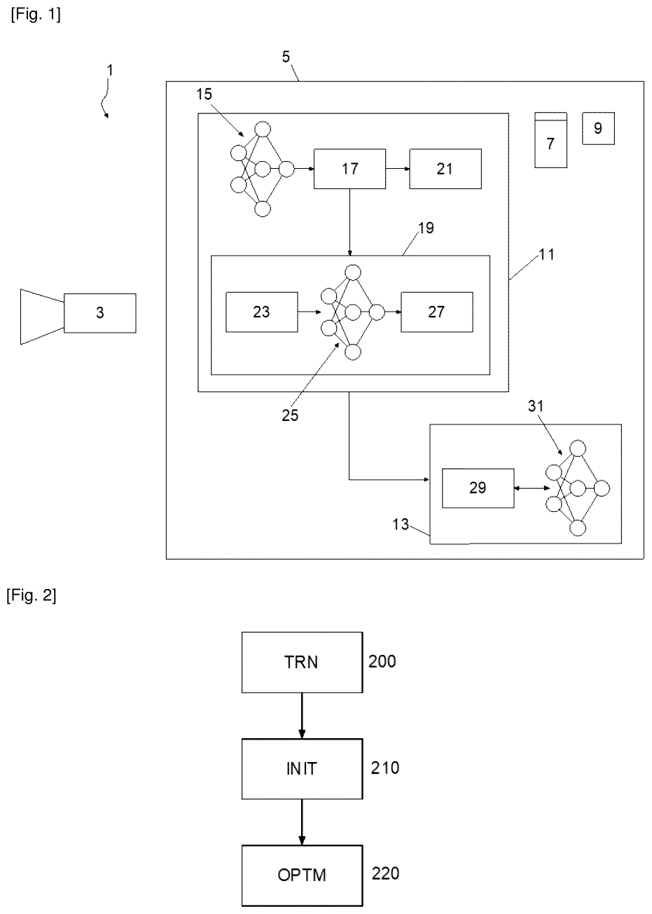

FIG. 1 illustrates a system 1 comprising a photographic sensor 3 and a system 5.

The photographic sensor 3 is arranged to receive electromagnetic radiation—and more particularly visible light—from a scene and to convert this radiation into an electrical signal. This electrical signal is intended to be digitised, for example by an analogue-to-digital converter, then amplified and processed to obtain a digital image.

The photographic sensor 3 is a photosensitive surface formed by a matrix of active elements preferred to as photosites. Each photosite can be likened to an elementary sensor—of the photodiode type—arranged to convert the light received into an electric current. Each photosite operates according to the principle of the photoelectric effect: incident photons extract electrons from the photosites.

Furthermore, the photosite matrix of the photographic sensor 3 is coupled to a colour filter array (CFA), i.e. a mosaic of colour filters arranged in such a way that each photosite is associated with a colour filter. Indeed, the photosites are sensitive to the light intensity and not to the colour; the colour filter array thus separates the colours. The Bayer array is the most widely used of the various known colour filter arrays. The Bayer array is made up of 50% green filters, 25% red filters and 25% blue filters.

The analogue image obtained directly by the photographic sensor 3 is in the form an irradiance map or irradiance image. Each pixel of this irradiance map or image corresponds to a photosite. Thus, the irradiance map is in the form of a matrix, each pixel of which has a positive real value characteristic of the irradiance measured at the corresponding photosite.

To generate a digital image, the photographic sensor 3 is arranged to apply, pixel by pixel, a transformation S to the irradiance map. The function S is a function which, at a positive real value, associates an integer belonging to a set P_{q}, i.e. the set of integers between 0 and 2^{q}-1. The photographic sensor 3 is then said to have a depth of q bits.

In addition, the exposure time of the map considered needs to be taken into account. The exposure time—also referred to as the exposure time or shutter speed—is the length of time the photographic sensor 3 is exposed to light.

Each pixel of the digital image obtained is calculated as follows:

$$y ( u ) = S ( Δ tx ( u ) )$$

where: —u is a given pixel,
y(u) is the value of the pixel u of the digital image,
x(u) is the value of the pixel u of the irradiance map, and
Δt is the exposure time.

The output of the photographic sensor 3 is therefore a black and white matrix image, each pixel of which has an integer value characterising the quantity of photons collected by the corresponding photosite.

Typically, the digital image obtained by the photographic sensor 3 is in the form of a RAW file.

The device 5 is arranged to form an image of a first spatial resolution from a plurality of pairs each formed by an image of a second spatial resolution and an exposure time. It needs to be understood here that, within a given pair, the exposure time corresponds to the exposure time of the associated image having the second spatial resolution.

More generally, the device 5 is arranged to form, from a burst of images, an image whose quality—in particular the level of detail—is superior to that of the images of the burst of images.

The term “level of detail” means here that the image formed by the device 5 has a lower noise level, and optionally a spatial resolution greater than or equal to that of the images in the burst of images or a higher dynamic range. In photography, the dynamic range refers to the ratio between the highest and lowest light intensity that a photographic sensor can capture.

The first spatial resolution is therefore greater than or equal to the second spatial resolution. It should be noted in particular that the device 5 can be used simply to lower the noise level without increasing the spatial resolution, for example for a burst of images from a dark or night scene, in which case the first spatial resolution of the image formed by the device 5 is equal to the second spatial resolution of the images in the burst of images.

For simplification, the image having the first spatial resolution is referred to as a “high-resolution image”, while the images having the second spatial resolution are referred to as “low-resolution images” in the following description.

Furthermore, with regard to the respective formats of the high-resolution image and the low-resolution image, the device 5 can be configured so that the low-resolution images received are RAW files—or raw images—while the high-resolution image formed is an irradiance map or image.

It should also be noted that the low-resolution images and their respective exposure times can be received by the device 5 from the photographic sensor 3, in which case the system 1 forms a system for capturing a burst of low-resolution images and forming from this burst of low-resolution images, a high-resolution image.

The device 5 can also be arranged to receive low-resolution images from a plurality of photographic sensors, such as the photographic sensor 3 or to receive low-resolution images from any memory or storage platform. It is thus understood that the device 5 can be completely dissociated from the photographic sensor 3.

The device 5 is therefore arranged to receive a set Y of low-resolution images yₖ and a set Δ of exposure times Δtₖ, and to form a high-resolution image \hat{x}. Here, k is a natural integer between 1 and K, where K is the number of pairs formed by a low-resolution image yₖ and an associated exposure time Δtₖ.

The low-resolution images yₖ include a reference low-resolution image yₖ₀ against which the alignment of each of the other low-resolution images yₖ is to be evaluated. In general, the reference low-resolution image yₖ₀ is the central low-resolution image of the burst of images yₖ. However, the reference low-resolution image yₖ₀ can also be the first low-resolution image received by the device 5.

The low-resolution images yₖ of the same scene are taken in a burst and can therefore be ordered chronologically, for example by using a time marker attached to each low-resolution image yₖ. It is understood here that the terms “central low-resolution image” and “first low-resolution image” relate to the chronological order of the low-resolution images yₖ.

As illustrated in FIG. 1, the device 5 comprises a memory 7, a processor 9, an initialisation module 11 and an optimisation module 13.

The memory 7 is configured to store instructions which when implemented by the processor 9 cause the device 5 to function. In particular, such instructions enable the formation of a high-resolution image \hat{x} from a plurality of pairs each formed by a low-resolution image yₖ and an associated exposure time Δtₖ.

The memory 7 can also be arranged to store low-resolution images received by the device 5 and their respective exposure times.

The memory 7 can denote any data storage medium for receiving and storing digital data, for example a hard disk, a semi-conductor disk, also known as a solid-state drive (SSD), or more generally any computer hardware enabling data to be stored on flash memory.

The memory 7 can also be random access memory or a magneto-optical disk. A combination of a plurality of types data storage can also be envisaged.

The processor 9 can be implemented in any known manner, for example in the form of a microprocessor, a programmable logical device (PLD) or a dedicated chip such as a Field Programmable Gate Array (FPGA) or System on Chip (SoC), a grid of computing resources, a microcontroller or any other specific form with the computing power required to implement the method for forming a high-resolution image \hat{x} described above. One or more of these elements may also be in the form of application-specific electronic circuits (ASIC). A combination of processors and electronic circuits can also be envisaged.

A method for forming a high-resolution image \hat{x} from a plurality of pairs each formed by a low-resolution image yₖ and an exposure time Δtₖ will now be described with reference to FIG. 2.

As illustrated in FIG. 2, this method, implemented by the device 5, comprises a training phase 200, an initialisation phase 210 and an optimisation phase 220.

The training phase 200 will be discussed at the end of the description.

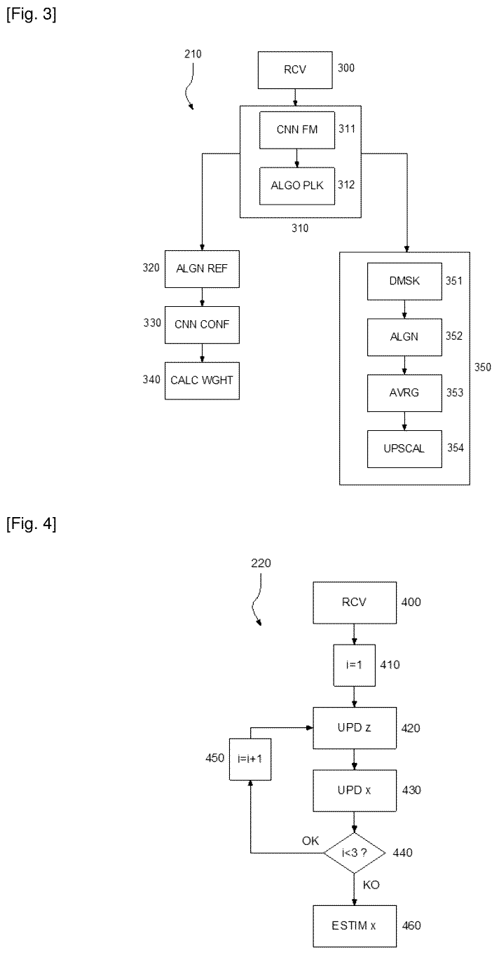

The initialisation phase 210 is implemented by the initialisation module 11 and is illustrated in more detail in FIG. 3.

As illustrated in FIG. 1, the initialisation module 11 comprises a convolutional neural network 15, an estimator 17, a deghosting unit 19 and a processing unit 21.

In an operation 300, the initialisation module 11 receives a plurality of pairs each formed by a low-resolution image yₖ and an associated exposure time Δtₖ.

The set Y of low-resolution images yₖ and the set Δ of exposure times Δtₖ are for example transmitted to the device 5 by the photographic sensor 3.

In operation 310, the estimator 17 estimates, for each low-resolution image yₖ, a distortion parameter pₖ by applying a Lucas-Kanade algorithm.

The Lucas-Kanade method is a differential method known to the person skilled in the art and which makes it possible to estimate, for a given image, an optical flow characterising an apparent movement of an object present in the captured scene and caused by a movement of the photographic sensor used. This method is based on the principle that, in the vicinity of a given image pixel, the optical flow is constant. The equation of the optical flow is generally resolved, within the vicinity considered, by at least a squares method.

In the context of the invention, the estimator 17 compares each low-resolution image yₖ to the reference low-resolution image yₖ₀ to estimate the distortion parameter pₖ which therefore corresponds to an optical flow between the low-resolution image yₖ and the reference low-resolution image yₖ₀. In other words, the estimator 17 estimates the optical flow pₖ between each low-resolution image yₖ and the reference low-resolution image yₖ₀.

The distortion parameters pₖ are features of a distortion operator Wₖ (also referred to as a “warping operator”) which reflects the shaking or movements of the photographic sensor during the low-resolution image yₖ acquisition.

Given that the Lucas-Kanade algorithm takes the reference low-resolution image yₖ₀ as its reference image, it can be deduced that the distortion operator Wₖ₀ corresponding to the reference low-resolution image yₖ₀ is the identity.

In the embodiment described here, the operation 310 is implemented by the operations 311 and 312 described in the following—and which consist of suboperations of the operation 310. This embodiment uses the convolutional neural network 15.

Thus, in operation 311, the convolutional neural network 15 receives, as input, the low-resolution images yₖ and generates, as output, a feature map FMₖ for each low-resolution image.

In operation 312, the estimator 17 applies the Lucas-Kanade algorithm to each feature map FMₖ to estimate the distortion parameter pₖ associated with each low-resolution image yₖ.

In particular, each feature map FMₖ can be processed by the estimator 17 in the form of a Gaussian pyramid. In image processing, a pyramid refers to a multi-resolution representation of an image in which the image is present in a plurality of distinct spatial resolutions—the image of highest spatial resolution forming the base of the pyramid, while the image of lowest spatial resolution forms the apex. Each spatial resolution of the image thus forms a level of the pyramid.

In this case, the Gaussian pyramid comprises for example six spatial resolutions, i.e. six levels.

It is known to apply the Lucas-Kanade algorithm to images in the form of a pyramid. Such a Pyramidal Lucas-Kanade (PLK) algorithm consists, for comparing two images, comparing corresponding levels of the pyramids representing the respective images. Typically, three iterations of the Lucas-Kanade algorithm are implemented at each level.

In other words, in the present case, the estimator 17 models each feature map FMₖ as a Gaussian pyramid and applies a Lucas-Kanade algorithm to determine the optical flow between the corresponding spatial resolutions of the Gaussian pyramid modelling the feature map FMₖ and the Gaussian pyramid modelling the feature map FMₖ₀. This results, after comparison of the respective levels two-by-two, in the distortion parameter pₖ of the low-resolution image yₖ.

The distortion parameter pₖ thus corresponds to an optical flow between the feature map FMₖ and the feature map FMₖ₀ of the reference low-resolution image yₖ₀.

Alternatively, the estimator 17 directly applies the Lucas-Kanade algorithm to low-resolution images yₖ to estimate the distortion parameter pₖ associated with each. It is therefore understood that the convolutional neural network 15 is optional and that the estimator 17 can estimate the distortion parameters pₖ without the feature maps FMₖ.

The distortion parameters pₖ are transmitted to the deghosting unit 19 and to the processing unit 21.

The deghosting unit 19 is arranged to generate, for each low-resolution image yₖ, a deghosting weight Wₖ. The deghosting weight wₖ characterises both the exposure time Δtₖ of the low-resolution image yₖ and its alignment with respect to the reference low-resolution image yₖ₀. As a result, the deghosting unit 19 makes it possible to give each low-resolution image yₖ, for the purposes of implementing the optimisation phase 220 by the optimisation module 13, a weighting that is greater as the low-resolution image yₖ considered has a high exposure time Δtₖ relative to other low-resolution images yₖ and a better alignment relative to the reference low-resolution image yₖ₀.

As illustrated in FIG. 1, the deghosting unit 19 comprises an alignment unit 23, a convolutional neural network 25 and a computer 27.

In operation 320, the alignment unit 23 aligns, by interpolation, the reference low-resolution image yₖ₀ as a function of each distortion parameter pₖ.

The interpolation performed by the alignment unit 23 is for example a bilinear interpolation which has the advantage of being rapid and offering satisfactory quality. However, other interpolation methods can be used by the alignment unit 23, in particular bicubic interpolation or spline interpolation.

In other words, for each distortion parameter pₖ, the alignment unit 23 aligns the reference low-resolution image yₖ₀. The reference low-resolution image yₖ₀ aligned as a function of the distortion operator Wₖ associated with the low-resolution image yₖ is denoted Wₖyₖ₀.

In operation 330, the convolutional neural network 25 receives, as input, each low-resolution image yₖ and the aligned reference low-resolution image Wₖyₖ₀ as a function of the associated distortion parameter pₖ and generates, as output, a confidence factor g_{ρ}.

It is understood here that a confidence factor g_{ρ}is generated for each low-resolution image yₖ or, more exactly, for each distortion operator Wₖ.

In operation 340, the computer 27 calculates, for each low-resolution image yₖ, an deghosting weight Wₖ as a function of the corresponding exposure time Δtₖ and the associated confidence factor g_{ρ}.

Each deghosting weight wk can be calculated as follows

$${w}_{k} = \frac{Δ {t}_{k} {m}_{c} ( {y}_{k} )}{{\sum }_{j = 1}^{K} Δ {t}_{j} {m}_{c} ( {y}_{j} )} \cdot {g}_{ρ} ( {y}_{k} , {W}_{k} {y}_{k 0} )$$

where: —Wₖ is the deghosting weight calculated for the low-resolution image yₖ,
m_{c}( [symbol] ) is a binary mask replacing by zero any pixel value lower than or equal to a threshold C,
g_{ρ}is the confidence factor parameterised by a parameter ρ of the convolutional neural network 25.

The binary mask m_{c} is used to exclude saturated pixels from each low-resolution image yₖ.

It should be noted that, contrary to the method proposed by inventors B. Lecouat, J. Ponce and J. Mairal (2021), the present invention performs deghosting that takes into account, if necessary, the heterogeneity of low-resolution images. This is because the deghosting weights wₖ allow greater weight to be given to low-resolution images yₖ with a higher exposure time Δtₖ.

As mentioned above, the respective distortion parameters pₖ of the low-resolution images yₖ generated by the estimator 17 are also transmitted to the processing unit 21.

The processing unit 21 is arranged to form an initial high-resolution image x₀ for the implementation of the optimisation phase 220 by the optimisation module 13. This initial high-resolution image x₀ is intended, during the optimisation phase 220, to form a starting point for the formation of the high-resolution image \hat{x}.

In operation 350, the processing unit 21 applies demosaicking and scaling at least to the reference low-resolution image (yk₀) to obtain an initial high-resolution image x₀.

More precisely, such scaling to increase the spatial resolution is referred to as upward conversion. The scaling factor is denoted s in the following description.

Such an upward conversion can be achieved by interpolation. Again, the interpolation method used by the processing unit 21 can be bilinear interpolation, bicubic interpolation or spline interpolation.

It should be noted that scaling is not necessary in cases where the image formed by the device 5 has the same spatial resolution as the images in the image burst received. As explained above, this is particularly the case when the image burst is a dark or nocturnal scene.

Advantageously, the processing unit 21 forms the initial high-resolution image x₀ from all the low-resolution images yₖ and not only from the reference low-resolution image yₖ₀. In such as case, the operation 350 is implemented by the processing unit 21 by the implementation of operations 351, 352, 353 and 354 described below—and which in fact constitute sub-operations of the operation 350.

Thus, during operation 351, the processing unit 21 applies demosaicking to each low-resolution image yₖ.

During operation 352, the processing unit 21 aligns each demosaicked low-resolution image yₖ by interpolation as a function of the associated distortion parameter pₖ.

As with operation 320, a plurality of interpolation methods can be used by the processing unit 21, in particular bilinear interpolation and also bicubic interpolation or spline interpolation.

In operation 353, the processing unit 21 forms a low-resolution image by averaging demosaicked and aligned low-resolution images.

Finally, in operation 354, the processing unit 21 scales the low-resolution image formed to obtain the initial high-resolution image x₀.

Again, scaling—or up-conversion—is only implemented if the device 5 is arranged to form an image with a higher spatial resolution than the images of the burst of images received.

Referring again to FIG. 2, the method continues with an optimisation phase 220 implemented by the optimisation module 13 and illustrated in more detail in FIG. 4.

The optimisation module 13 is arranged to minimise a quadratic energy function with two variables: an estimation variable of the first spatial resolution image x and an auxiliary variable z.

The quadratic energy function with two variables to be minimised is for example as follows:

$$\frac{1}{2} {\sum }_{k = 1}^{K} {‖ {w}_{k} \cdot ( {y}_{k} - {A}_{k} z ) ‖}_{F}^{2} + \frac{η}{2} {‖ x - z ‖}_{F}^{2} + λ Ω ( x )$$

with:

$${A}_{k} = Δ {t}_{k} C {D}_{s} B {W}_{k}$$

where: —x is the estimation variable of the high-resolution image,
z is the auxiliary variable,
∥ [symbol] ∥ _{F} is a norm,
η and λ are parameters of the two-variable quadratic energy function,
Ω( [symbol] ) is a regularisation function,
C is a binary mask modelling a matrix of coloured filters,
s is the scaling factor applied to obtain the initial high-resolution image x₀,
Dₛ is a decimation operator characterised by the scaling factor, and
B is a blurring operator.

As illustrated in FIG. 1, the optimisation module 13 comprises an updating unit 29 and a convolutional neural network 31.

In operation 400, the optimisation module 13 receives the low-resolution images yₖ, the associated distortion parameters pₖ, the initial high-resolution image x₀ and the deghosting weights wₖ associated respectively with low-resolution images yₖ.

The remainder of the optimisation phase 220 consists of minimising the quadratic energy function with two variables by successive iterations according to a half-quadratic splitting (HQS) method. Each iteration comprises updating the auxiliary variable z and updating the high-resolution image estimation variable x.

It should be noted that in the preceding publication by inventors B. Lecouat, J. Ponce and J. Mairal (2021), the quadratic energy function to be minimised is a three-variable function. Indeed, in addition to the auxiliary variable z and the high-resolution image estimation variable x, the distortion parameters pₖ—collected in a vector p—are also updated using a Gauss-Newton approach. Each iteration is thus burdened by an additional operation, this requires additional computing resources and is time-consuming. Indeed, in the present invention, the distortion parameters pₖ do not vary during the optimisation phase: the distortion parameters pₖ estimated by the estimator 17 are used directly.

In operation 410, the optimisation module 13 initialises the auxiliary variable z and the high-resolution image estimation variable x with the initial high-resolution image x₀.

Furthermore, a local variable i, corresponding to the number of iterations, is initialised to 1.

In operation 420, the updating unit 29 updates the auxiliary variable z by a gradient descent as a function of low-resolution images yₖ, associated distortion parameters pₖ and deghosting weights wₖ.

For example, the updating unit 29 updates the auxiliary variable z by gradient descent as follows:

$$z ← z - δ ( η ( z - x ) + {\sum }_{k = 1}^{K} {A}_{k}^{T} ( {w}_{k}^{2} \cdot ( {A}_{k} z - {y}_{k} ) ) )$$

where: δ is a parameter of the gradient descent.

In operation 430, the optimisation module 13 updates the high-resolution image estimation variable x as a function of the updated auxiliary variable z.

Advantageously, the convolutional neural network 31 receives, as input, the updated auxiliary variable z and generates, as output, the updated high-resolution image estimation variable x.

Furthermore, the convolutional neural network 31 can implement “weight-sharing” from one iteration to the next.

The convolutional neural network 31 thus enables the denoising of the high-resolution image estimation variable x with each iteration.

Alternatively, it is also possible to use the proximal operator G of the regularisation function Ω to update the estimation variable of the high-resolution image x and therefore not have to use a convolutional neural network such as the convolutional neural network 31. The use of the proximal operator G has in particular been the subject of a publication by N. Parikh and S. P. Boyd (2014): “Proximal Algorithms” (Foundations and Trends in Optimization, vol. 1, No. 3, p. 127-239).

The denoising can thus be implemented by bilateral filtering or by a proximal operator of a regularisation function such as total variation regularization (TVR).

However, preferably, the convolutional neural network 31 is used to update the high-resolution image estimation variable by an operator G_{ω}verifying:

$${G}_{ω} ( z , γ )$$

where: —ω is a parameter of the convolutional neural network 31, and
γ is a parameter verifying: γ=λ/η.

In operation 440, the optimisation module 13 determines whether a predetermined number of iterations—or number of loops—has been reached. In the example illustrated in FIG. 4, this number of iterations is fixed to 3. However, the number of iterations can be strictly greater than 3.

If the predetermined number of iterations has not been reached, the optimisation phase 220 continues with an operation 450 during which the local variable i is incremented by a step of 1.

However, if the predetermined number of iterations has been reached, the optimisation phase 220 ends with an operation 460 which corresponds to the output of the estimated high-resolution image \hat{x}, i.e. the high-resolution image estimation variable x updated during the last iteration.

The estimated high-resolution image \hat{x} is therefore the image formed by the device 5 from the plurality of pairs, each formed by a low-resolution image yₖ and an exposure time Δtₖ.

As explained above, the device 5 uses one or more convolutional neural networks. Typically, at least one convolutional neural network of the convolutional neural networks 15, 25 and 31 has a U-net type architecture.

A U-net is a “fully convolutional” neural network generally dedicated to computer vision and more particularly to semantic segmentation, in particular in the biomedical field.

A U-net comprises a contraction part—also referred to as an “encoder—formed by an assembly of convolution layers, rectified linear unit (ReLU) and max-pooling to recover the context of an image and an expansion part—also referred to as a “decoder”—which uses the information obtained by the contraction part to obtain precise localisation by transposed convolution and ascending concatenation. The expansion part thus makes it possible to recover the initial size of the analysed image.

For example, K. Zhang et al. describe the use of a U-net type convolutional neural network in publication (2020): “Deep unfolding network for image-super-resolution” (Proceedings of the Conference on Computer Vision and Pattern Recognition (CVPR), p. 3217-3226).

However, other convolutional neural network architectures can be used.

As a result and as illustrated in FIG. 2, it may be advantageous to implement a pre-training phase 200 of the device 5 with a training data set. This training data set comprises a high-resolution image and a plurality of pairs, each formed by a low-resolution image and an exposure time.

For simplification, the notations used below to denote the training data sets are similar to those used to describe the initialisation phase 210 and the optimisation phase 220.

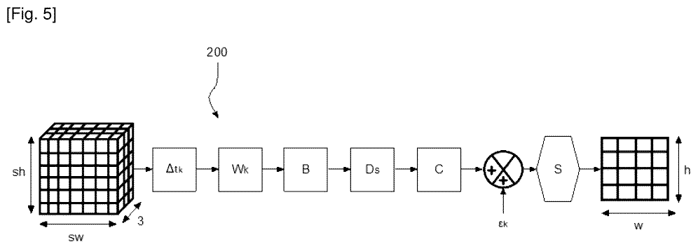

The pre-training phase 200, and more specifically the generation of the training data sets, is illustrated in FIG. 5.

The generation of the training data set is semi-synthetic. In other words, the principle is to start from a high-resolution image x⁽¹⁾ and apply successive operations to obtain low-resolution images yₖ⁽¹⁾.

In the example illustrated in FIG. 5, the high-resolution image x⁽¹⁾ is an image of dimensions sh×sw×x3. Here, the dimension 3 corresponds to the RGB (red, green, blue) channels: the high-resolution image x⁽¹⁾ is a colour image. The low-resolution images yₖ⁽¹⁾ are here images of dimensions h×w. There is therefore a scale factor s between the raw images yₖ⁽¹⁾ generated and the original high-resolution image x⁽¹⁾.

For each low-resolution image yₖ⁽¹⁾ to be generated, an exposure time Δtₖ⁽¹⁾ and a distortion operator Wₖ⁽¹⁾ are used as inputs. The distortion operator Wₖ⁽¹⁾ is used to simulate shaking or movements of a photographic sensor.

Furthermore, for all the low-resolution images yₖ⁽¹⁾ to be generated, a blur operator B⁽¹⁾ is used, a decimation operator Dₛ⁽¹⁾ to reduce the resolution of the image by a scale factor s and a binary mask C⁽¹⁾ modelling a matrix of coloured filters.

A noise εₖ⁽¹⁾ specific to each low-resolution image yₖ⁽¹⁾ is also added to the resulting image. Each low-resolution image yₖ⁽¹⁾ is thus generated as follows from the high-resolution image x:

$${y}_{k}^{( 1 )} = {A}_{k}^{( 1 )} {x}^{( 1 )} + {ε}_{k}^{( 1 )}$$

with

$${A}_{k}^{( 1 )} = Δ {t}_{k}^{( 1 )} {C}^{( 1 )} {D}_{s}^{( 1 )} {B}^{( 1 )} {W}_{k}^{( 1 )}$$

where: —x⁽¹⁾ is the high-resolution image of the training data set,
yₖ⁽¹⁾ is the k-th low-resolution image of the training data set,
Δtₖ⁽¹⁾ is the exposure time of the low-resolution image yₖ⁽¹⁾,
Wₖ⁽¹⁾ is the distortion operator associated with the low-resolution image yₖ⁽¹⁾,
C⁽¹⁾ is the binary mask modelling a matrix of coloured filters,
Dₛ⁽¹⁾ is the decimation operator characterised by the scaling factor,
B⁽¹⁾ is the blurring operator, and
εₖ⁽¹⁾ is the noise associated with the low-resolution image yₖ⁽¹⁾.

Furthermore, when the high-resolution image x⁽¹⁾ is an irradiance map and the low-resolution images yₖ⁽¹⁾ generated are raw images, it is advisable to apply the function S described above, which, to a positive real value, associates an integer between 0 and 2^{q}-1, q being a strictly positive integer. We then arrive at the following expression:

$${y}_{k}^{( 1 )} = S ( {A}_{k}^{( 1 )} {x}^{( 1 )} + {ε}_{k}^{( 1 )} )$$

The training data set generated in this way is then used to train the device 5. In other words, the device 5 receives the low-resolution images yₖ⁽¹⁾ and exposure times Δtₖ⁽¹⁾ from the training data set and applies them to the initialisation phase 210 and the optimisation phase 220 detailed above. The estimated image \hat{x}⁽¹⁾ is compared to the image x⁽¹⁾ of the training data set—which is therefore known—, which makes it possible to parameterise the device 5, and in particular the various convolutional neural networks used.

The parameters to be learned are for example the weights of the layers of the convolutional neural network 15, the parameter ρ of the confidence factor g_{ρ}and the weights of the layers of the convolutional neural network 25, the parameters λ and η of the quadratic energy function minimised by the optimisation module 13, the parameter δ of the gradient descent implemented by the updating unit 29, the parameters ω and γ and the weights of the layers of the convolutional neural network 31.

By gathering all of these parameters into a vector θ, the device 5 can be modelled by an interference engine arranged to apply F_{θ} to a set Y⁽¹⁾ of low-resolution images yₖ⁽¹⁾ and to a set Δ(1) of associated exposure times Δtₖ⁽¹⁾ and derive therefrom an estimated high-resolution image \hat{x}⁽¹⁾.

In other words:

$${\hat{x}}^{( 1 )} = {F}_{θ} ( {Y}^{( 1 )} , {Δ}^{( 1 )} )$$

Advantageously, the pre-training phase 200 is supervised by using a plurality of training data sets each comprising a high-resolution image x⁽ⁱ⁾ and a plurality of pairs each formed by a low-resolution image yₖ⁽¹⁾ and an exposure time Δtₖ⁽ⁱ⁾. The supervised pre-training phase 200 makes it possible to parameterise the device 5 so as to minimise the following quantity:

$${\sum }_{i = 1}^{n} {‖ {x}^{( i )} - {\hat{x}}^{( i )} ‖}_{1} = {\sum }_{i = 1}^{n} {‖ {x}^{( i )} - {F}_{θ} ( {Y}^{( i )} , {Δ}^{( i )} ) ‖}_{1}$$

where: —x⁽ⁱ⁾ is the high-resolution image of the i-th training data set,
\hat{x}⁽ⁱ⁾ is the high-resolution image estimated by the device 5 from the i-th training data set,
Y⁽ⁱ⁾ is the set of low-resolution images yₖ⁽ⁱ⁾ from the i-th training data set,
Δ⁽ⁱ⁾ is the set of exposure times Δtₖ⁽ⁱ⁾ from the i-th training data set, and
n is the number of training data sets.

Although the present disclosure has been described with reference to one or more examples, workers skilled in the art will recognize that changes may be made in form and detail without departing from the scope of the disclosure and/or the appended claims.

1. A device for forming an image having a first spatial resolution from a plurality of pairs each formed by an image having a second spatial resolution lower than or equal to the first spatial resolution and an exposure time, said device comprising:
an initialisation module arranged to receive the images having the second spatial resolution and comprising:
an estimator arranged to estimate, for each image having the second spatial resolution, a distortion parameter by applying a Lucas-Kanade algorithm, and
a processing unit arranged to apply, to at least one reference image having the second spatial resolution out of the images having the second spatial resolution, demosaicking and, in response to the second spatial resolution being lower than the first spatial resolution, scaling to obtain an initial image having the first spatial resolution, and
an optimisation module arranged to receive the images having the second spatial resolution, associated distortion parameters and the initial image having the first spatial resolution and to minimise a quadratic energy function parameterised by an estimation variable of the image having the first spatial resolution and an auxiliary variable, said estimation variable of the image having the first spatial resolution and said auxiliary variable being initialised on the basis of the initial image having the first spatial resolution, the minimisation being performed by successive iterations each comprising updating the auxiliary variable by a gradient descent as a function of the images having the second spatial resolution and associated distortion parameters and updating the estimation variable of the image having the first spatial resolution as a function of the updated auxiliary variable, wherein the initialisation module is arranged to further receive the respective exposure times of the images having the second spatial resolution and further comprises:
an alignment unit arranged to align by interpolation the reference image having the second spatial resolution as a function of each distortion parameter,
a convolutional neural network arranged to receive, as input, each image having the second spatial resolution and the aligned reference second spatial resolution image as a function of the associated distortion parameter and to generate, as output, a confidence factor,
a computer arranged to calculate, for each image having the second spatial resolution, a deghosting weight as a function of the corresponding exposure time and the associated confidence factor,
and wherein the optimisation module is arranged to also receive the deghosting weights associated respectively with the images having the second spatial resolution and comprises:
an updating unit arranged to update the auxiliary variable by gradient descent as a further function of the deghosting weights.

2. A device according to claim 1, wherein the initialisation module further comprises:
a convolutional neural network arranged to receive, as input, the images having the second spatial resolution and to generate, as output, a feature map for each image having the second spatial resolution,
and wherein the estimator is arranged to apply the Lucas-Kanade algorithm to each feature map to estimate the distortion parameter associated with each image having the second spatial resolution.

3. A device according to claim 2, wherein the estimator is arranged to process each feature map, for application of the Lucas-Kanade algorithm, in the form of a Gaussian pyramid.

4. The device according to claim 1, wherein the optimisation module further comprises:
a convolutional neural network arranged to receive, as input, the updated auxiliary variable and to generate, as output, the estimation variable of the updated image having the first spatial resolution.

5. The device according to claim 4, wherein the convolutional neural network of the optimisation module is arranged to implement weight sharing from one iteration to the other.

6. The device according to claim 1, wherein the computer is arranged to calculate each deghosting weight (wₖ) as follows:
$${w}_{k} = \frac{Δ {t}_{k} {m}_{c} ( {y}_{k} )}{{\sum }_{j = 1}^{K} Δ {t}_{j} {m}_{c} ( {y}_{j} )} \cdot {g}_{ρ} ( {y}_{k} , {W}_{k} {y}_{k 0} )$$
where:
yₖ is the k-th image having the second spatial resolution,
wₖ is the deghosting weight calculated for the image yₖ having the second spatial resolution,
Δtₖ is the exposure time of the image yₖ having the second spatial resolution,
K is the number of images having the second spatial resolution,
m_{c}(·) is a binary mask replacing by zero any pixel value lower than or equal to a threshold c,
g_{ρ}is the confidence factor parameterised by a parameter ρ of the convolutional neural network,
Wₖ is a distortion operator characterised by the distortion parameter (pₖ) associated with the image yₖ having second spatial resolution, and
yₖ₀ is the reference image having the second spatial resolution.

7. The device according to claim 1, wherein the alignment unit is arranged to align the reference image having the second spatial resolution as a function of each distortion parameter by bilinear interpolation.

8. The device according to claim 1, wherein the processing unit is arranged to demosaick each image having the second spatial resolution, to align by interpolation each demosaicked the image having the second spatial resolution as a function of the associated distortion parameter, to form an image having the second spatial resolution by averaging demosaicked and aligned the images having the second spatial resolution and, in response to the second spatial resolution being lower than the first spatial resolution, to scale the formed second spatial resolution image to obtain the initial image having the first spatial resolution.

9. The device according to claim 1, wherein the updating unit is arranged to update the auxiliary variable (z) by gradient descent as follows:
$$z ← z - δ ( η ( z - x ) + {\sum }_{k = 1}^{K} {A}_{k}^{T} ( {w}_{k}^{2} \cdot ( {A}_{k} z - {y}_{k} ) ) )$$
with:
$${A}_{k} = Δ {t}_{k} C {D}_{s} B {W}_{k}$$
where:
z is the auxiliary variable,
x is the estimation variable of the image having the first spatial resolution,
yₖ is the k-th image having the second spatial resolution,
K is the number of images having the second spatial resolution,
wₖ is the deghosting weight associated with the image yₖ having the second spatial resolution,
Δtₖ is the exposure time of the image yₖ having the second spatial resolution,
Wₖ is a distortion operator characterised by the distortion parameter (pₖ) associated with the image yₖ having the second spatial resolution,
C is a binary mask modelling a matrix of coloured filters,
s is the scaling factor used to obtain the initial image (x₀) gaving the first spatial resolution,
Dₛ is a decimation operator characterised by the scaling factor s,
B is a blurring operator,
δ is a parameter of the gradient descent, and
η is a parameter of the quadratic energy function with two variables.

10. The device according to claim 1, wherein the optimisation module is arranged to implement three successive iterations.

11. The device according to claim 1, wherein the convolutional neural network has a U-net type architecture.

12. A method for forming an image having a first spatial resolution from a plurality of pairs each formed by an image having a second spatial resolution lower than or equal to the first spatial resolution and an exposure time, said method being implemented by a device and comprising:
an initialisation phase comprising the following operations:
receiving the images having the second spatial resolution,
estimating, for each image having the second spatial resolution, a distortion parameter by applying a Lucas-Kanade algorithm, and
applying, to at least one reference image having the second spatial resolution out of the images having the second spatial resolution, a demosaicking and, in response to the second spatial resolution being lower than the first spatial resolution, a scaling to obtain an initial image having the first spatial resolution, and
an optimisation phase comprising the following operations:
receiving the images having the second spatial resolution, the associated distortion parameters and the initial image having the first spatial resolution, and
minimising a quadratic energy function parameterised by an estimation variable of the image having the first spatial resolution and an auxiliary variable, said estimation variable of the image having the first spatial resolution and said auxiliary variable being initialised on the basis of the initial image having the first spatial resolution, the minimisation being performed by successive iterations each comprising updating the auxiliary variable by a gradient descent as a function of the images having the second spatial resolution and associated distortion parameters and updating the estimation variable of the image having the first spatial resolution image as a function of the updated auxiliary variable,
wherein the initialisation phase comprises the following operations:
additionally receiving the respective exposure times of the images having the second spatial resolution,
aligning by interpolation the reference image having the second spatial resolution as a function of each distortion parameter,
using a convolutional neural network receiving, as input, each image having the second spatial resolution and the aligned second spatial resolution image as a function of the associated distortion parameter and generating, as output, a confidence factor, and
calculating, for each image having the second spatial resolution, an deghosting weight as a function of the corresponding exposure time and the associated confidence factor,
and wherein the optimisation phase comprises the following operations:
additionally receiving the deghosting weights respectively associated with the images having the second spatial resolution, and
updating the auxiliary variable by gradient descent as a further function of the deghosting weights.

13. A method according to claim 12, wherein the method further comprises a pre-training phase of the device with training data set comprising an image (x⁽¹⁾) having the first spatial resolution and a plurality of pairs each formed by an image (yₖ⁽¹⁾) having the second spatial resolution and an exposure time (Δtₖ⁽¹⁾), each image (yₖ⁽¹⁾) having the second spatial resolution being generated from the image (x⁽¹⁾) having the first spatial resolution as follows:
$${y}_{k}^{( 1 )} = {A}_{k}^{( 1 )} {x}^{( 1 )} + {ε}_{k}^{( 1 )}$$
with:
$${A}_{k}^{( 1 )} = Δ {t}_{k}^{( 1 )} {C}^{( 1 )} {D}_{s}^{( 1 )} {B}^{( 1 )} {W}_{k}^{( 1 )}$$
where: —x⁽¹⁾ is the image having the first spatial resolution of the training data set,
yₖ⁽¹⁾ is the k-th image having the second spatial resolution of the training data set,
Δtₖ⁽¹⁾ is the exposure time of the image yₖ⁽¹⁾ having the second spatial resolution,
Wₖ⁽¹⁾ is a distortion operator associated with the image yₖ⁽¹⁾ having the second spatial resolution,
C⁽¹⁾ is a binary mask modelling a matrix of coloured filters,
Dₛ⁽¹⁾ is a decimation operator characterised by a scaling factor s,
B⁽¹⁾ is a blurring operator,
εₖ⁽¹⁾ is a noise associated with the image yₖ⁽¹⁾ having the second spatial resolution.

14. The method according to claim 13, wherein the pre-training phase is supervised using a plurality of training data sets each comprising an image (x⁽ⁱ⁾) having the first spatial resolution and a plurality of pairs each formed by an image (yₖ⁽ⁱ⁾) having the second spatial resolution and an exposure time (Δtₖ⁽ⁱ⁾), said supervised pre-training phase making it possible to parameterise said device so as to minimise the following quantity:
$${\sum }_{i = 1}^{n} {‖ {x}^{( i )} - {\hat{x}}^{( i )} ‖}_{1}$$
where:
x⁽ⁱ⁾ is the image having the first spatial resolution of the i-th training data set,
\hat{x}⁽ⁱ⁾ is the image having the first spatial resolution estimated by the device from the i-th training data set, and
n is the number of training data sets.

15. A non-transitory computer readable medium comprising instructions stored thereon which when executed by at least one processor implements a method for forming an image having a first spatial resolution from a plurality of pairs each formed by an image having a second spatial resolution lower than or equal to the first spatial resolution and an exposure time, said method comprising:
an initialisation phase comprising the following operations:
receiving the images having the second spatial resolution,
estimating, for each image having the second spatial resolution, a distortion parameter by applying a Lucas-Kanade algorithm, and
applying, to at least one reference image having the second spatial resolution out of the images having the second spatial resolution, a demosaicking and, in response to the second spatial resolution being lower than the first spatial resolution, a scaling to obtain an initial image having the first spatial resolution, and
an optimisation phase comprising the following operations:
receiving the images having the second spatial resolution, the associated distortion parameters and the initial image having the first spatial resolution, and
minimising a quadratic energy function parameterised by an estimation variable of the image having the first spatial resolution and an auxiliary variable, said estimation variable of the image having the first spatial resolution and said auxiliary variable being initialised on the basis of the initial image having the first spatial resolution, the minimisation being performed by successive iterations each comprising updating the auxiliary variable by a gradient descent as a function of the images having the second spatial resolution and associated distortion parameters and updating the estimation variable of the image having the first spatial resolution image as a function of the updated auxiliary variable,
wherein the initialisation phase comprises the following operations:
additionally receiving the respective exposure times of the images having the second spatial resolution,
aligning by interpolation the reference image having the second spatial resolution as a function of each distortion parameter,
using a convolutional neural network receiving, as input, each image having the second spatial resolution and the aligned second spatial resolution image as a function of the associated distortion parameter and generating, as output, a confidence factor, and
calculating, for each image having the second spatial resolution, an deghosting weight as a function of the corresponding exposure time and the associated confidence factor,
and wherein the optimisation phase comprises the following operations:
additionally receiving the deghosting weights respectively associated with the images having the second spatial resolution, and
updating the auxiliary variable by gradient descent as a further function of the deghosting weights.
